(19) United States
(12) Patent Application Publication
(10) Pub. No.: US 2011/0119601 A1
(43) Pub. Date: May 19, 2011

(54) METHOD AND APPARATUS FOR PRESENTING A WEB APPLICATION INSTANCE TO MULTIPLE USER INTERFACES

(75) Inventors: Dennis KNOTHE, Vancouver (CA); Atte Lahtiranta, Bedford, MA (US)

(73) Assignee: Nokia Corporation, Espoo (FI)

(21) Appl. No.: 12/622,215

(22) Filed: Nov. 19, 2009

(51) Int. Cl. G06F 3/01

(52) U.S. Cl. 715/760

(57) ABSTRACT

An approach is provided for presenting a web application instance using multiple user interfaces. A web application user interface is associated with one of a plurality of modes of a web application instance. Content is caused to be associated with the one mode. Presentation of the content is caused via the web application user interface.

### BACKGROUND

Service providers (e.g., wireless, cellular, etc.) and device manufacturers are continually challenged to deliver value and convenience to consumers by, for example, providing compelling network services and advancing underlying technologies. One area of interest has been the development of services and technologies using web applications. In particular, service providers and device manufacturers are developing software applications that can be installed and executed on devices for presentation to users. However, service providers and device manufacturers face significant technical challenges to providing resource efficient software applications.

### SOME EXAMPLE EMBODIMENTS

According to one embodiment, a method comprises associating a web application user interface with one of a plurality of modes of a web application instance. The method also comprises causing, at least in part, content to be associated with the one mode. The method further comprises causing, at least in part, presentation of the content via the web application user interface.

According to another embodiment, an apparatus comprising at least one processor, and at least one memory including computer program code, the at least one memory and the computer program code configured to, with the at least one processor, cause, at least in part, the apparatus to associate a web application user interface with one of a plurality of modes of a web application instance. The apparatus is also caused to cause, at least in part, content to be associated with the one mode. The apparatus is further caused to cause, at least in part, presentation of the content via the web application user interface.

According to another embodiment, a computer-readable storage medium carrying one or more sequences of one or more instructions which, when executed by one or more processors, cause, at least in part, an apparatus to associate a web application user interface with one of a plurality of modes of a web application instance. The apparatus is also caused to cause, at least in part, content to be associated with the one mode. The apparatus is further caused to cause, at least in part, presentation of the content via the web application user interface.

According to another embodiment, an apparatus comprises means for associating a web application user interface with one of a plurality of modes of a web application instance. The apparatus also comprises means for causing, at least in part, content to be associated with the one mode. The apparatus further comprises means for causing, at least in part, presentation of the content via the web application user interface.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system with user equipment capable of providing multiple user interfaces for presenting a web application instance, according to one embodiment;

FIG. 1B is a diagram of the components of a web runtime capable of providing multiple interfaces for presenting a web application instance, according to one embodiment;

FIG. 2 are flowchart of a process for utilizing multiple user interfaces to access a web application instance, according to one embodiment;

FIG. 3 is a block diagram of processes for utilizing multiple user interfaces to access a web application instance, according to one embodiment;

FIGS. 4 and 5 are diagrams of user interfaces utilized in the processes of FIGS. 3 and 4, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for providing multiple user interfaces for presenting a web application instance are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

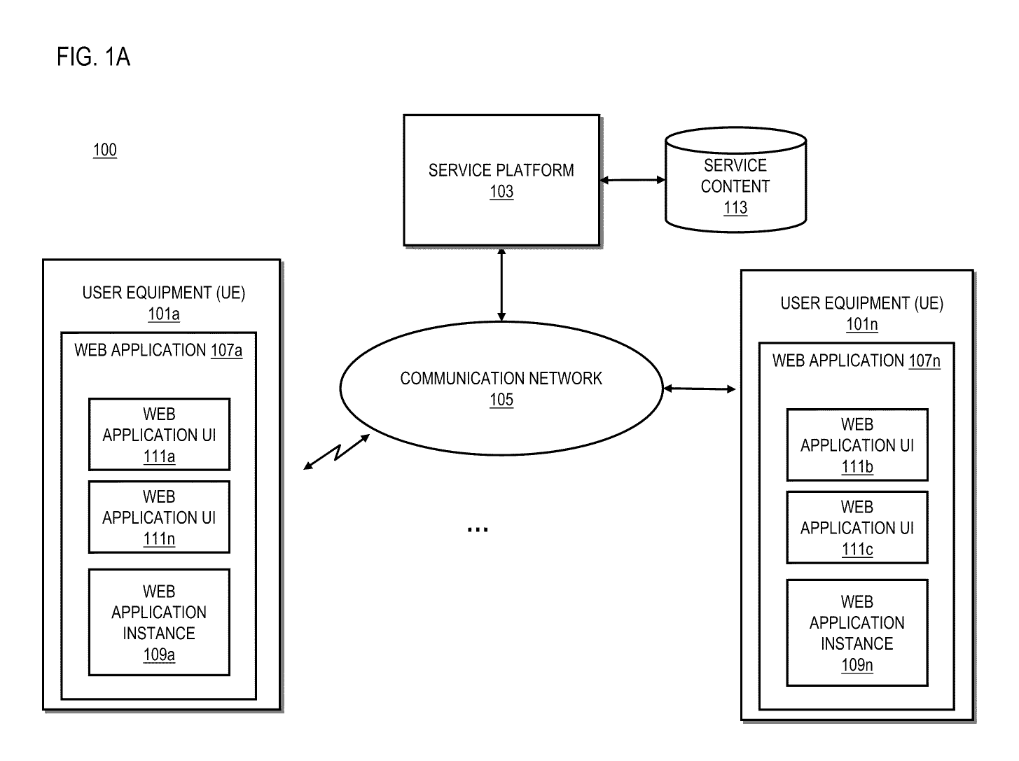

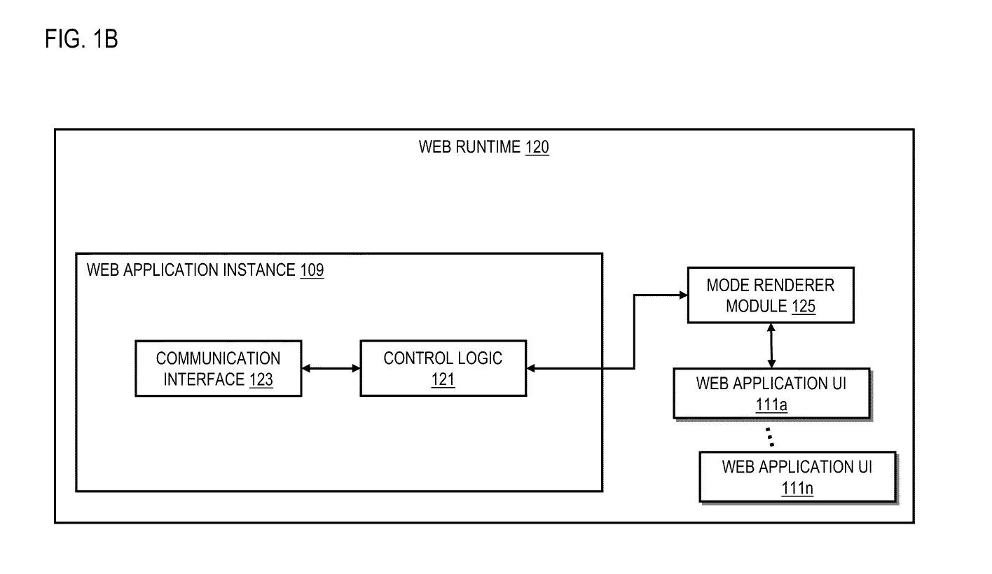

FIG. 1A is a diagram of a system with user equipment (UE) capable of providing multiple user interfaces for presenting a web application instance, according to one embodiment. As discussed previously, it is becoming popular for service providers and device manufacturers to develop software applications (e.g., web applications) that may be presented to users. Many UEs may execute one or more of these software applications. Thus, applications and services, implemented using web technologies, may run as its own instance of a web runtime environment (e.g., using a browser) or run as its own window or frame in the web runtime environment. Further, in many scenarios, UEs execute more than one instance of the same web application. For example, a UE may include a view of the web application embedded in a home screen as well as a view of the web application embedded in other native applications (e.g., a music application, a media application, an instant messaging application, etc.) that may be compiled to execute on the operating system of the UE, or a view of the web application as a standalone application. However, such approaches have a large overhead because each instance or use of the web application requires the use of software libraries, heaps, Document Object Models (DOM), etc. that need to be loaded. Moreover, a similar problem occurs if a window instances or frame instances are used in place of a full instance.

To address this problem, system 100 of FIG. 1A introduces the capability to provide multiple web application user interfaces for presenting a single web application instance. Because there is only a single web application instance, resources need not be wasted to support multiple web application instances; e.g., processing overhead is minimized. In certain embodiments, a web application may include components (e.g., objects, functions, data structures, elements, etc.) written in one or more software languages such as JavaScript™, Java, Hyper Text Markup Language (HTML), Extensible Markup Language (XML), a combination thereof, etc. Further, the web application may or may not utilize the Internet or the web while executing. Moreover, the web application may include software objects that are self-contained collections of data and methods and used, for example, in object-oriented programming (OOP). By way of example, web applications (e.g., a map application, a music application, widgets, etc.) may be based on standard web technologies (e.g., web runtime (WRT)—a web application runtime environment included in many browsers), that serve as frontends or clients to web-based content or other content. Moreover, a web application may be configured to execute using a single web runtime instance that can provide “views” to web application user interfaces (UIs). In certain embodiments, web application UIs are user interfaces that may be presented to a user of a UE. Exemplary web applications UIs include a home screen of a UE, a native application that may have embedded within a user interface for the web application, a native application associated with the web application, etc. The web application UIs may be interactive and present content based, at least in part, on input received by the web application UI. Further, the web application UIs may include the use of rich media (e.g., ADOBE FLASH) or embedded media.

As shown in FIG. 1A, system 100 includes one or more user equipment 101 with connectivity to a service platform 103 over a communication network 105. For sake of simplicity, FIG. 1A depicts only two UEs (e.g., 101a-101n) and one service platform 103 in the system 100. However, it is contemplated that the system 100 may support any number of UEs 101 and service platforms 103, depending on the capacity of the communication network 105. In one embodiment, the network capacity may be determined based on available bandwidth, available connection points, and/or the like. The service platform 103 may include one or more services (e.g., music services, mapping services, navigation services, media services, purchasing services, gaming services, etc.) to provide to a user of the UE 101 via a web application 107a-107n. The web application 107 may be executed on a web runtime utilizing a web application instances 109a-109n and respective web application UIs 111a-111n. In certain embodiments, the service platform 103 provides service content 113 associated with the service(s) to the web application 107. Utilizing the system 100, one application instance on a web runtime of the UE 101 is capable of publishing a number of different interfaces to multiple native applications wishing to present the respective interfaces.

FIG. 1B is a diagram of the components of a web runtime 120 capable of providing multiple interfaces for presenting a web application instance 109, according to one embodiment. By way of example, the web runtime 120 includes one or more components for providing multiple interfaces for presenting a web application instance 109. It is contemplated that the functions of these components may be combined in one or more components or performed by other components of equivalent functionality. In this embodiment, the web runtime 120 includes a web application instance 109 including control logic 121, a communication interface 123, and a mode renderer module 125, and web application user interfaces 111.

A user or developer of the web application 107 may wish to have or provide access to the web application 107 provided via web application UIs 111. In the past, on web runtime environments, to provide access to different user interfaces of an application, additional instances of web applications and web runtimes 120 would need to be initiated, wherein each instance consumes memory and processor resources. Consequently, this would limit scalability with respect to usage of applications on the UE 101, as the UE 101 has relatively limited resources. To address these limitations, a single web application instance 109 is used to provide a plurality of rich user interfaces 111 to the user.

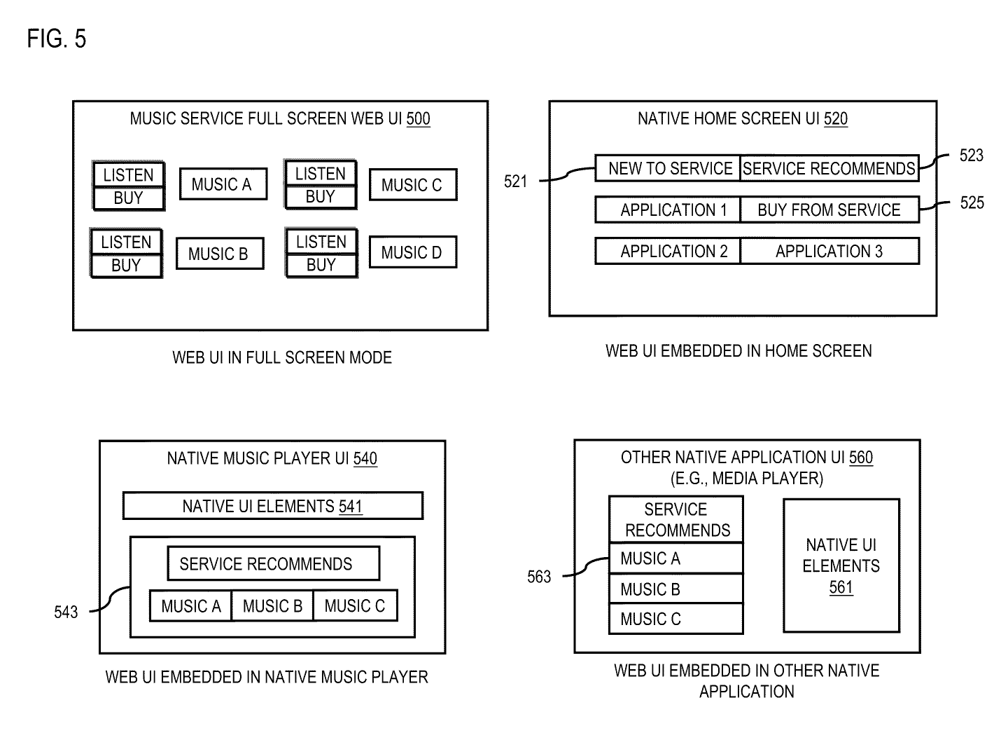

The web application 107 may be installed on the user's UE 101. During the installation process, web application UIs 111 may be embedded into native applications (e.g., a native music player, a native media player, etc.), the native home screen, etc. Examples of web application UIs 111 embedded in native user interfaces are provided in FIG. 5. In various embodiments, during installation or during runtime, the web application UI 111 may be provided identifiers (e.g., global unique identifiers (GUID)) associated with various modes or views that may be provided to the web application UI 111 by a mode renderer module 125 during execution.

In certain embodiments, modes or views are segments (portions) of a web page, which may be described using elements that allow dynamic manipulation of a portion of the web page without reloading the entire web page. Thus, asynchronous updates or requests may be used to update the portion. Such asynchronous update techniques may include, e.g., XMLHttpRequests and other methods of obtaining data from the service platform 103. An approach to create the portion may include using elements such as HTML “div” elements that define divisions or sections of an HTML document. Other similar tags or elements may be used to define divisions or sections of a web application instance 109 to be rendered to a user interface. These modes may be used to retrieve and process contents associated with other portions of the web page. Further, these modes may be used to specify user interfaces to interact with users via one or more web application UIs 111.

During execution of the web application 107 on the web runtime 120, a web application instance 109 is called and stored in a memory of the UE 101 for execution. By way of example, the web application instance 109 may be executed on the web runtime 120. Moreover, the web application instance 109 may use a communication interface 123 to utilize services of the service platform 103 via the UE 101. Data from the service platform 103 may be stored in a memory of the UE 101. Further, the control logic 121 may update modes of the web application instance 109 with the data collected from the service platform 103. Moreover, in certain scenarios, the control logic 121 may update the modes of the web application instance 109 without data from the service platform 103. Thus, in certain scenarios, the web application 107 need not collect or send any information to the service platform 103. Furthermore, more than one mode of the web application instance 109 may be updated by the control logic 121. Each of the modes may share the same memory space, heap, software libraries and/or other resources.

Also, the mode renderer module 125 may provide one or more modes to the web application UI 111. In certain scenarios, the mode renderer module 125 may receive information (e.g., a native user interface identifier associated with the mode) from the web application UI 111, as well as other web application UIs 111, about which mode the web application UI 111 would like to provide to the user. The mode renderer module 125 may then update that mode for use with the web application UI 111. The mode renderer module 125 may further maintain drawing ports for each mode. An image of a presentation of the mode may be drawn or published to the web application UI 111. Further, the control logic 121 may receive input from the web application UI 111 to dynamically modify the presentation (e.g., by retrieving data from the service platform 103 or processing the input to retrieve local data).

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). The UE 101 may include a user interface can include various methods of communication. For example, the user interface can have outputs including a visual component (e.g., a screen), an audio component, a physical component (e.g., vibrations), and other methods of communication. User inputs can include a touch-screen interface, a scroll-and-click interface, a button interface, a microphone, etc.

By way of example, the UE 101 and the service platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the web application 107 and the service platform 103 interact according to a client-server model. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

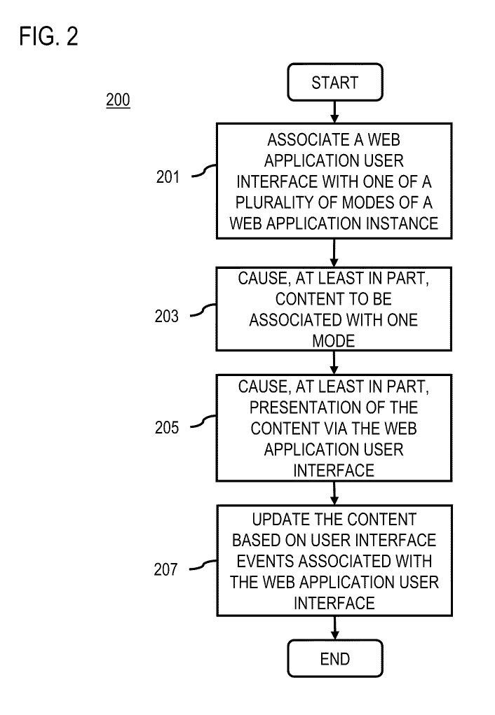

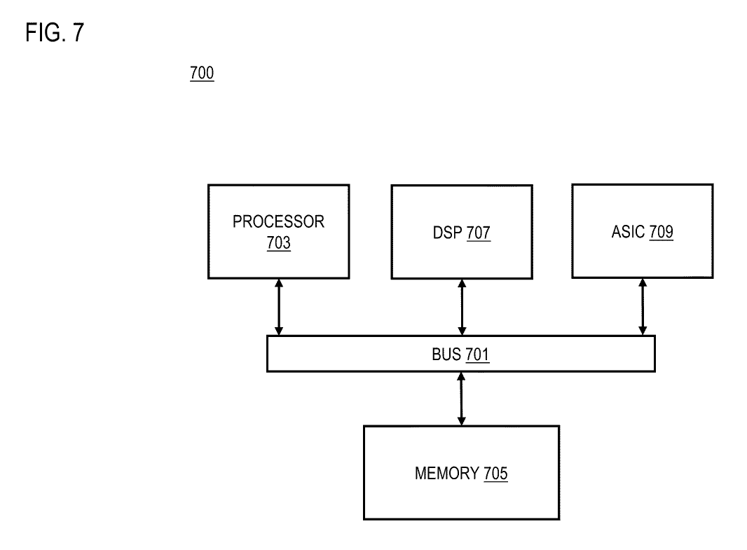

FIG. 2 is a flowchart of a process for utilizing multiple user interfaces to access a web application instance, according to one embodiment. In one embodiment, the web runtime 120 performs the process 200 and is implemented in, for instance, a chip set including a processor and a memory as shown FIG. 7. A web application 107 executing on the web runtime 120 may be activated by a UE 101 on which the web application 107 resides upon. The UE 101 may activate the web application 107 in response to a user input, during startup, in response to a native application requesting that services of the web application 107, etc. In step 201, the web runtime 120 associates a web application user interface 111 with one of a plurality of modes of a web application instance 109. As previously noted, in certain embodiments, a mode is a segment of a web page that can be used to provide one or more web application user interfaces 111 to the user via stand alone or native applications. Each mode may be associated with an identifier that may be provided to web application UIs 111. When requesting services of the web application instance 109, the web application UIs 111 may provide the identifier associated with the mode the particular web application UI 111 selects to use to interface with the user. As previously noted, the web application UI 111 may be embedded, for example, in a native application, in a native home screen, and/or in a full view web application native user interface wrapper. A full view web application native user interface wrapper allows for a web application 107 to be accessed as a native application. Alternatively or additionally, associations can be made based on a descriptor file, such as a web application configuration data. For example Table 1 displays exemplary code for associations.

TABLE 1

<modes>
<mode name=“Music player embedded” guid=“0x123456789”
htmlid=“music_embedded” />
<mode name=“Fullscreen” guid= “0” htmlid= “standalone” />
<mode name=“Homescreen” guid=“0x87654321” htmlid=
“homescreen” />
</modes>

The web application 107 may additionally have code specifying the identifiers (e.g., specifying that a div or other web application UI identifier or web application UI mode corresponds to “music_embedded”). Using the web application configuration data, another web application UI 111 may also be associated with another mode.

Then, at step 203, the web runtime 120 determines content and causes the content to be associated with one mode of the plurality of modes. This can be accomplished by the mode renderer module 125 and/or the control logic 121. The web runtime 120 can determine the which web application UIs 111 are active by receiving an activity flag from the web application UI 111 or a native application associated with the web application UI 111. In certain embodiments, the web runtime 120 may determine active modes using a software function. Moreover, the web runtime 120 can change the mode using a software function that handles the mode change (e.g., determine whether the mode is active or inactive). Thus, the web runtime 120 can determine active modes. A mode may be active if it is currently being displayed on a user interface associated with the UE 101. Additionally or alternatively, a mode may be active if there is a need to update the content of the mode regardless of its display status. The content may be retrieved from a service platform 103 or via determinations (e.g., a game web application 107 need not access the service platform 103 while executing the game) made by the web application 107. The content, which is associated with the mode, is thus also associated with a web application UI 111 that is active. Once the content is determined, the web application 107 may cause, at least in part, presentation of the content via the web application UI 111 (step 205). Thus, an active web application UI 111 may be used to show the presentation to a user of the UE 101. Similarly, the web application 107 may present the contents of other modes via other web application UIs 111.

At step 207, the web runtime 120 may update the content based on user interface events associated with the web application UI 111. A user interface event may be any event, such as a user input event (e.g., inputted text, using a pointer, etc.), a data event from a service platform 103 (e.g., a change in content at the service platform 103), or another data event (e.g., from the processing of web page data utilizing a timing event such as an alarm) that may cause the content to be presented to change. Further, the mode may be loaded and presented without need for updating the whole web page. The web runtime 120 receives information about the event, can determine if any updates need to be made to the content of any of the modes, and then presents the updated content. In certain embodiments, only modes that are active are presented. In other embodiments, only one mode is active at a time.

Under certain scenarios, the process 200 may be utilized to provide a framework for multiple applications. In this manner, the web runtime 120 executes multiple applications and provides views or modes to each of the applications to various web application user interfaces 111. As such, each web application may share common resources via a single web runtime 120 instance.

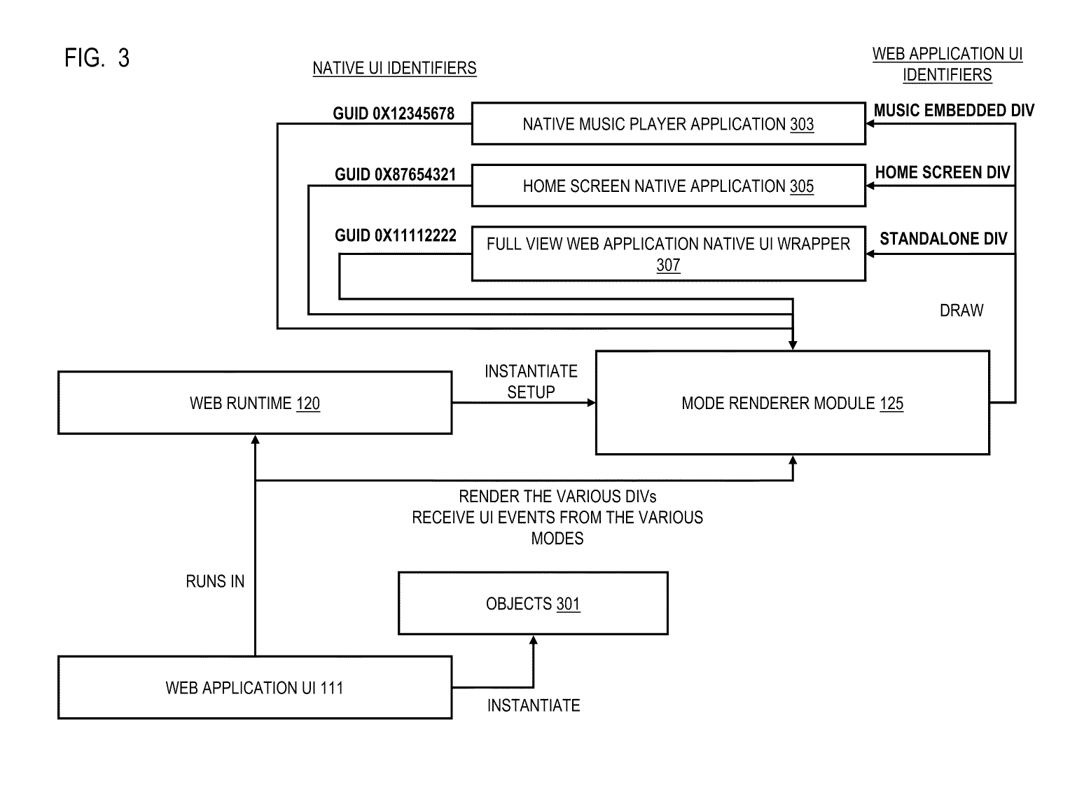

FIG. 3 is a block diagram of processes for utilizing multiple user interfaces to access a web application instance, according to one embodiment. In one embodiment, the processes are implemented in, for instance, a chip set including a processor and a memory as shown FIG. 7. A web application user interface 111 or other embeddable “browser control” user interface may be used to utilize a web application 107 running on a web runtime 120. The web runtime 120 can be invoked using a user input or via another event (e.g., a native application or home screen utilizing the services of the web application 107). Then, the web runtime 120 may execute a web application UI 111. The web runtime 120 may also cause the web application UI 111 to instantiate objects 301 associated with web application code of the web application UI 111 for use in executing the web application 107. Further, the web runtime 120 may instantiate the setup of a mode renderer module 125. The web runtime 120 may provide information about which mode 303, 305, 307 or modes the web application UI 111 uses (e.g., by providing an identifier (e.g., a GUID or other native UI identifier) of the mode 303, 305, 307 the web application UI 111 is using).

The mode renderer module 125 can set up drawing ports that may be used to display information to the web application UI 111. These drawing ports may be tied to modes (e.g., div segments or other segments identified by web application user interface identifiers) that are associated with the identifiers for the mode. Moreover, the mode renderer module 125 may maintain a drawing port for each of the modes 303, 305, 307 and draw respective content to the correct port (e.g., a port associated with the mode 303, 305, 307 associated with the web application UI 111). The content is then presented on the web application UI 111.

Further, a second web application UI (not shown) executing the same web application 107 can utilize the web runtime 120 and one or more of the objects 307 created. The second web application UI may provide the mode renderer module 125 with an identifier for the mode 303, 305, 307 the second web application UI wishes to present. This may be used to determine which port the mode renderer module 125 associates with the second web application UI and selection of the content to draw on the second web application UI.

Further, the web application UI 111 may be interactive in the determination of the content to draw. For example, the web application UI 111 may cause a user interface event as described above to change the presentation of the content. Moreover, a user interface event form the web application UI 111 may additionally modify or change content on the second web application UI if applicable.

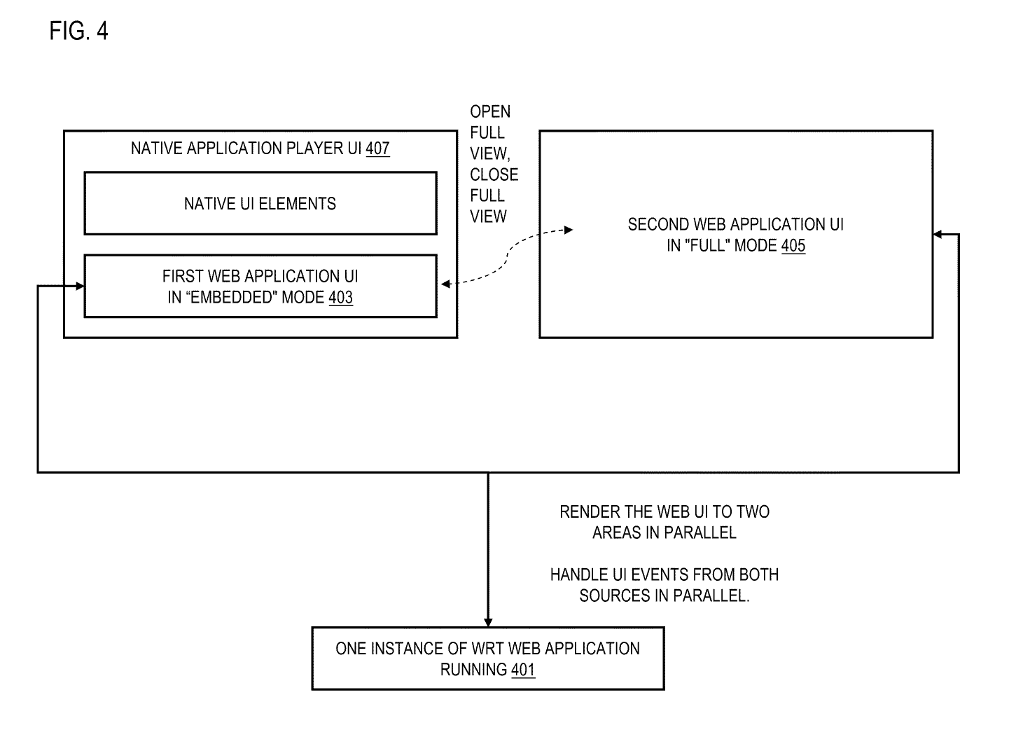

FIG. 4 is a diagram of user interfaces utilized in the processes of FIGS. 2 and 3, according to various embodiments. As shown, only one web runtime 401 of a web application is utilized by multiple web application UIs, a first web application UI 403 in an embedded mode and a second web application UI 405 in a “full” mode. In certain scenarios, both modes may be concurrently displayed. A full mode includes a full view web application in a native user interface wrapper. The embedded mode and the full mode are two exemplary modes of many possible modes, some of which are exemplified in FIG. 5. In one embodiment, the first web application UI 403 may open into the second web application UI 405. Additionally, the second web application UI 405 may close down to the first web application UI 403. Conventionally, opening the second web application UI 405 from the first web application UI to the second web application UI would include creating a new instance of the web runtime 401 and loading all of the necessary software libraries for the web application, which in turn consumes additional redundant resources. In the current embodiment, the second web application UI 405 may share many of the same resources as the first web application UI 403 because both share the same web runtime 401 of the web application. Moreover, to switch from the first web application UI 403 to the second web application UI 405, the UE 101, via the web application, may switch which mode is being displayed on a screen of the UE 101. In certain embodiments, the native application UI 407 and a wrapper of the second web application UI 405 select which mode is displayed. The web runtime 401 may render both web UIs in parallel, or may render one at a time, based on an activation flag. In certain embodiments, the web application may determine which mode(s) are active based on whether the mode is currently being presented via the UI of the UE 101. Moreover, the web runtime 401 may handle user interface events from both web application UIs 403, 405 in parallel.

In an exemplary scenario, the first web application UI 403 is embedded in a music related web application. Under this scenario, the JavaScript™ code is executing the web application on the web runtime 401. The user of the UE 101 may interact with the JavaScript™ code to perform functions (e.g., pan, click, point, enter text, initiate searches, etc.) and to switch the web application into a full mode. In this scenario, the second web application UI 405 also includes JavaScript™ code of the music web application. The web application may, via the JavaScript™ code, control when (e.g., based on a user interface event) and how to return to the native application user interface 407.

FIG. 5 is a diagram of user interfaces utilized in the processes of FIGS. 2 and 3, according to various embodiments. In this example, user interfaces include a full screen music service web user interface 500, a native home screen user interface 520 of the UE 101, a native music player user interface 540, and another native application user interface 560. As displayed on the full screen music service user interface 500 may provide services for listening and buying music. The music services web application may additionally be embedded in the native user interfaces 520, 540, 560.

Also, the native home screen UI 520 may include three web application user interfaces of different active modes of the web application, one web UI 521 targeted at new services available, a second web UI 523 targeted at content (e.g., music or media) that are recommended to the user by the service, and a third web UI 525 targeted at a shopping service associated with the music service web application. When one of these home screen user web interfaces are utilized, a full screen user interface of the web application may be opened as detailed in FIG. 4. Additionally or alternatively, the web user interfaces 521, 523, 525 may be updated and utilized as a user interface on the home screen.

In other examples, the native music player UI 540 and the other native application UI 560 includes native user interface elements 541, 561 such as functions to play music. Further, embedded in the native music player UI 540 or other native application UI 560 may be a UI 543, 563 representing a mode of the music service web application. The mode can interactively display and interact with the user via the embedded user interface.

With the above approach, users of UEs 101 can advantageously utilize a web application using multiple user interfaces with a single web runtime instance. In this manner, the web application may consume less UE 101 resources (e.g., memory, processor consumption) than if it were necessary to use multiple runtime instances to utilize the user interfaces. This approach further allows for the user to utilize more applications and user interfaces on the UE 101.

The processes described herein for providing multiple user interfaces for presenting a web application instance may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

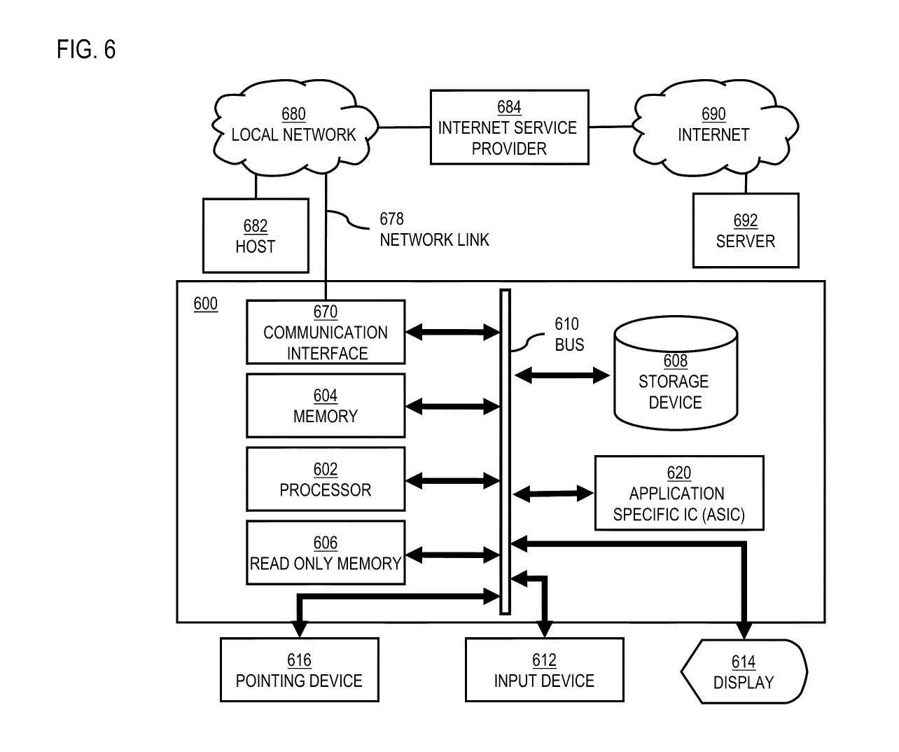

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide multiple user interfaces for presenting a web application instance as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing multiple user interfaces for presenting a web application instance.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to providing multiple user interfaces for presenting a web application instance. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for providing multiple user interfaces for presenting a web application instance. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing multiple user interfaces for presenting a web application instance, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection the communication network 105 providing services to the UE 101.

The term “computer-readable medium” as used herein to refers to any medium that participates in providing information to processor *˜02, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device *˜08. Volatile media include, for example, dynamic memory *˜04. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set 700 upon which an embodiment of the invention may be implemented. Chip set 700 is programmed to provide multiple user interfaces for presenting a web application instance as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of providing multiple user interfaces for presenting a web application instance.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide multiple user interfaces for presenting a web application instance. The memory 705 also stores the data associated with or generated by the execution of the inventive steps.

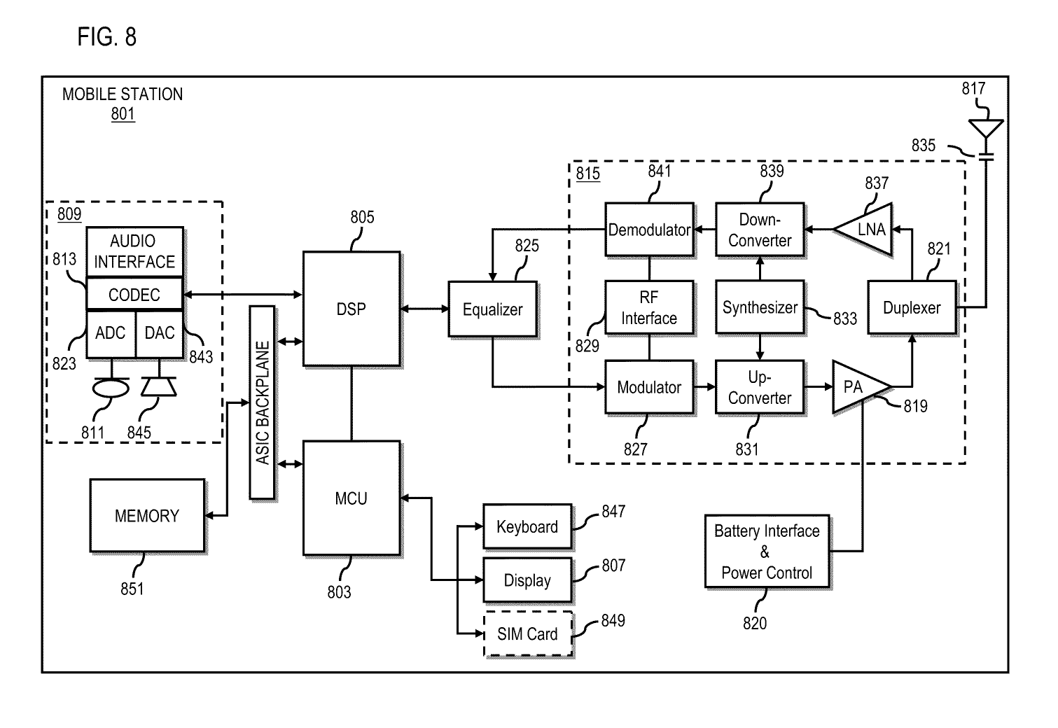

FIG. 8 is a diagram of exemplary components of a mobile terminal (e.g., handset) for communications, which is capable of operating in the system of FIG. 1A, according to one embodiment. In some embodiments, mobile terminal 800, or a portion thereof, constitutes a means for performing one or more steps of providing multiple user interfaces for presenting a web application instance. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing multiple user interfaces for presenting a web application instance. The display 8 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide multiple user interfaces for presenting a web application instance. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
associating a web application user interface with one of a plurality of modes of a web application instance;
causing, at least in part, content to be associated with the one mode; and
causing, at least in part, presentation of the content via the web application user interface.

2. A method of claim 1, wherein the content is associated with an element configured to allow dynamic manipulation of data associated with the web application instance.

3. A method of claim 2, further comprising:
receiving a user interface event associated with the web application instance; and
updating the content based on the user interface event.

4. A method of claim 1, further comprising:
determining that the one operating mode is an active operating mode, wherein the presentation is based, at least in part, on the determination.

5. A method of claim 1, further comprising:
causing, at least in part, initiation of an instance of a native application; and
embedding the web application user interface within the native application.

6. A method of claim 1, wherein the web application user interface is embedded within either a home screen, a native application, or a web runtime user interface wrapper.

7. A method of claim 1, further comprising:
associating another web application user interface with another one of the modes;
causing, at least in part, other content to be associated with the other mode;
causing, at least in part, presentation of the other content via the other web application user interface;
retrieving a web application configuration file; and
determining the respective associations of the one mode and the other mode based on the web application configuration data.

8. An apparatus comprising:
at least one processor; and
at least one memory including computer program code,
the at least one memory and the computer program code configured to, with the at least one processor, cause the apparatus to perform at least the following,
associate a web application user interface with one of a plurality of modes of a web application instance;
cause, at least in part, content to be associated with the one mode; and
cause, at least in part, presentation of the content via the web application user interface.

9. An apparatus of claim 8, wherein the content is associated with an element configured to allow dynamic manipulation of data associated with the web application instance.

10. An apparatus of claim 9, wherein the apparatus is further caused, at least in part, to:
receive a user interface event associated with the web application instance; and
update the content based on the user interface event.

11. An apparatus of claim 8, wherein the apparatus is further caused, at least in part, to:
determine that the one operating mode is an active operating mode, wherein the presentation is based, at least in part, on the determination.

12. An apparatus of claim 8, wherein the apparatus is further caused, at least in part, to:
cause, at least in part, initiation of an instance of a native application; and
embed the web application user interface within the native application.

13. An apparatus of claim 8, wherein the web application user interface is embedded within either a home screen, a native application, or a web runtime user interface wrapper.

14. An apparatus of claim 8, wherein the apparatus is further caused, at least in part, to:
associate another web application user interface with another one of the modes;
cause, at least in part, other content to be associated with the other mode;
cause, at least in part, presentation of the other content via the other web application user interface;
retrieve a web application configuration file; and
determine the respective associations of the one mode and the other mode based on the web application configuration data.

15. A computer-readable storage medium carrying one or more sequences of one or more instructions which, when executed by one or more processors, cause an apparatus to at least perform the following steps:
associating a web application user interface with one of a plurality of modes of a web application instance;
causing, at least in part, content to be associated with the one mode; and
causing, at least in part, presentation of the content via the web application user interface.

16. A computer-readable storage medium claim 15, wherein the content is associated with an element configured to allow dynamic manipulation of data associated with the web application instance.

17. A computer-readable storage medium of claim 16, wherein the apparatus is caused, at least in part, to further perform:
receiving a user interface event associated with the web application instance; and
updating the content based on the user interface event.

18. A computer-readable storage medium claim 15, wherein the apparatus is caused, at least in part, to further perform:
determining that the one operating mode is an active operating mode, wherein the presentation is based, at least in part, on the determination.

19. A computer-readable storage medium of claim 15, wherein the apparatus is caused, at least in part, to further perform:
causing, at least in part, initiation of an instance of a native application; and
embedding the web application user interface within the native application.

20. A computer-readable storage medium of claim 15, wherein the apparatus is caused, at least in part, to further perform:
associating another web application user interface with another one of the modes;
causing, at least in part, other content to be associated with the other mode;
causing, at least in part, presentation of the other content via the other web application user interface;
retrieving a web application configuration file; and
determining the respective associations of the one mode and the other mode based on the web application configuration data.
